(19) United States
(12) Patent Application Publication
(10) Pub. No.: US 2002/0192419 A1
(43) Pub. Date: Dec. 19, 2002

(54) Steaker sheet and method of printing half-cutting line of the same

(76) Inventor: Young Soo Lee, Seoul (KR)

Correspondence Address: GREENBLUM & BERNSTEIN, P.L.C., 1941 ROLAND CLARKE PLACE, RESTON, VA, 20191, US

(21) Appl. No.: 10/149,409

(22) PCT Filed: Oct. 15, 2001
(86) PCT No.: PCT/KR01/01732

(30) Foreign Application Priority Data
Oct. 17, 2000 (KR) 2000-28957 U

(51) Int. Cl. B32B 7/06; B32B 31/00; B32B 9/00

(52) U.S. Cl. 428/42.3; 428/195; 156/252

(57) ABSTRACT

Disclosed are a sticker sheet with half-cutting lines and a method for printing, on the sticker sheet, colored lines corresponding to the half-cutting lines. The sticker sheet has half-cutting lines formed by cutting respective peripheries of unit stickers and adapted to define these unit stickers, and printed colored lines corresponding to the half-cutting lines, to clearly define the shape of the stickers, so that the user can easily separate each sticker and conveniently use it. Also, where the process for forming half-cutting lines is carried out using a blade of a half-cutting tool stained with a paint, the colored lines can be printed, simultaneously with the formation of the half-cut lines. Accordingly the sticker sheet can be manufactured at substantially the same costs as those of conventional sticker sheets. Furthermore, since the colored lines correspond exactly to the half-cutting lines, they are not seen when the stickers are reattached to other objects.

### TECHNICAL FIELD

The present invention relates to a sticker sheet with half-cutting lines and a method for printing, on the sticker sheet, colored lines corresponding to the half-cutting lines. More particularly, the present invention relates to a sticker sheet with half-cutting lines adapted to separate unit stickers, and a method for printing, on the sticker sheet, colored lines corresponding to the half-cutting lines with a printing ink or paint, to allow the user to easily identify the lines.

### BACKGROUND ART

Referring to FIG. 1, a conventional sticker sheet is illustrated. As shown in FIG. 1, the sticker sheet includes a lower sheet 1 forming a base, an upper sheet 2 attached to the upper surface of the lower sheet 1, an adhesive 3 coated on the lower surface of the upper sheet 2, and a silicon layer 4 coated on the upper surface of the lower sheet 1 to allow easy separation of the adhesive 3.

The upper sheet 2 is defined with a plurality of unit stickers 2a. A half-cutting line 2b is formed along the periphery of each sticker 2a to allow the sticker to be separated from a portion 2c of the upper sheet where there is no unit sticker.

However, the conventional sticker sheet has a disadvantage in that since the unit stickers 2a are defined by very thin half-cutting lines 2b, it is difficult to easily macroscopically identify the shape of each sticker 2a, thereby making it inconvenient for the user to release the sticker 2a from the sticker sheet.

Therefore, the present invention has been made in view of the above problems, and it is an object of the present invention to provide a sticker sheet capable of allowing the user to easily identify the shape of unit stickers, without paying particular attention, so that it is conveniently used.

It is another object of the present invention to provide a method for conveniently and readily printing, on the sticker sheet, colored lines corresponding to the half-cutting lines without any increase in manufacturing costs.

In accordance with one aspect, the present invention provides a sticker sheet including a lower sheet forming a base, and an upper sheet attached to the lower sheet formed with half-cutting lines to define unit stickers, wherein the half-cutting lines are indicated by colored lines on an upper surface of the upper sheet.

In accordance with another aspect, the present invention provides a method for forming half-cutting lines adapted to separate unit stickers from an upper sheet included in a sticker sheet including a lower sheet, in addition to the upper sheet, comprising the steps of:

staining a blade of a half-cutting tool with a paint; and

cutting respective peripheries of unit stickers at the upper sheet using the paint-stained blade,

thereby forming the half-cutting lines while simultaneously printing, on an upper surface of the upper sheet, colored lines corresponding to the half-cutting lines.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view of a conventional sticker sheet;

FIG. 2 is a plan view of a conventional sticker sheet;

FIG. 3 is a cross-sectional view of sticker sheet according to an embodiment of the present invention; and

FIG. 4 is a plan view of a sticker sheet according to an embodiment of the present invention.

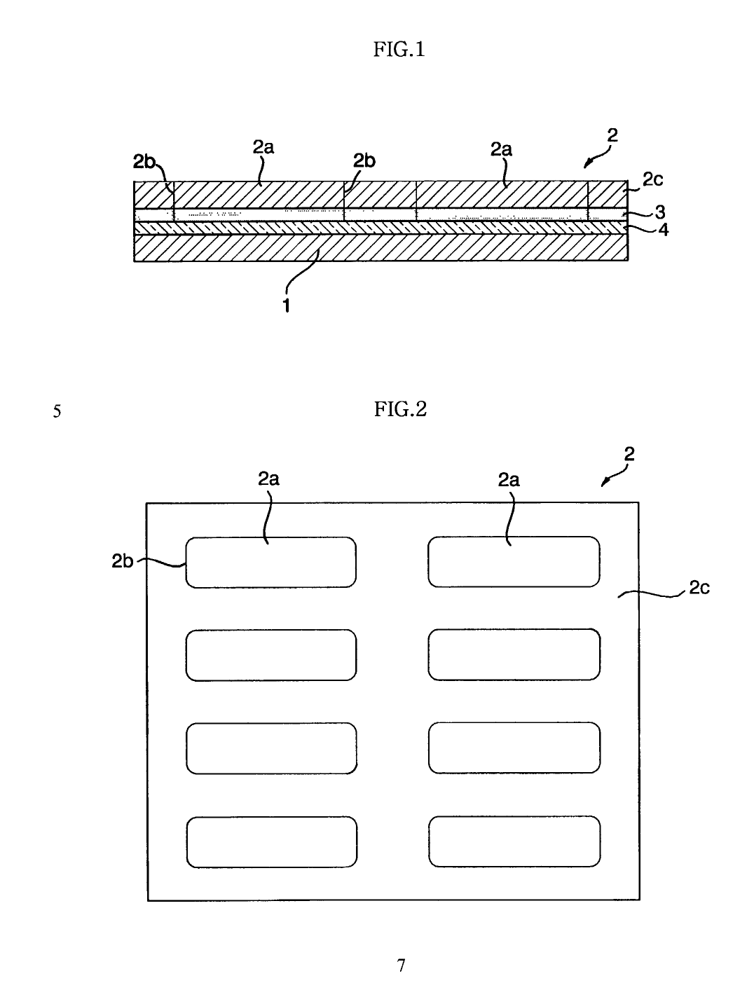

### BEST MODE FOR CARRYING OUT THE INVENTION

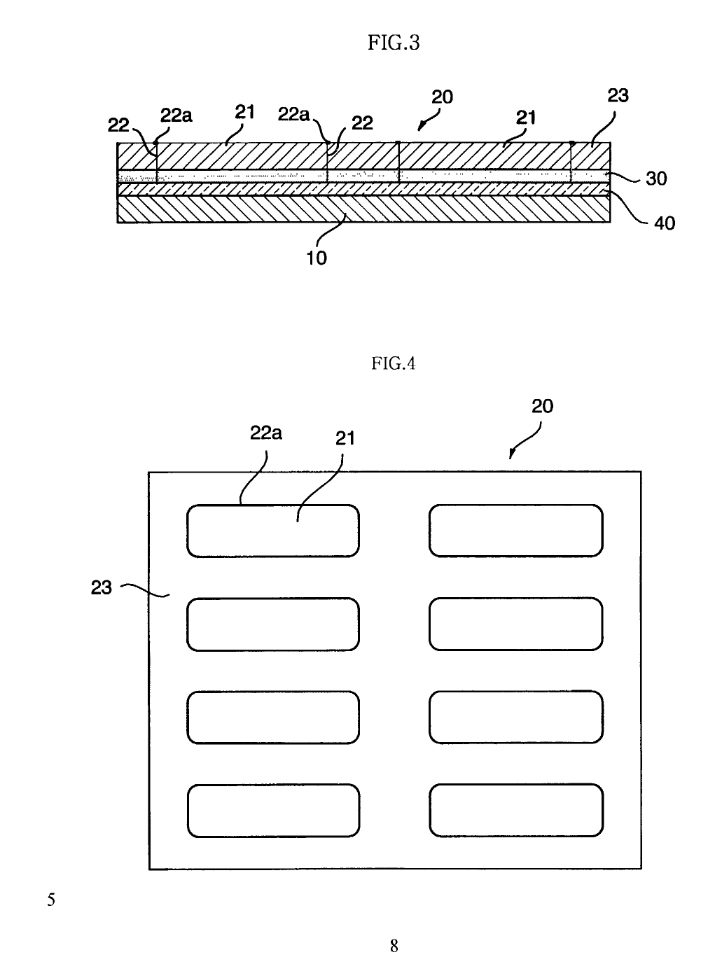

Referring to FIGS. 3 and 4, a sticker sheet according to an embodiment of the present invention is illustrated.

As shown in FIGS. 3 and 4, the sticker sheet includes a lower sheet 10 forming a base, an upper sheet 20 attached to the upper surface of the lower sheet 10 and defined with a plurality of unit stickers 21, an adhesive 30 coated on the lower surface of the upper sheet 20 and a silicon layer 40 coated on the upper surface of the lower sheet 10 to allow easy separation of the adhesive 30.

A half-cutting line 22 is formed along the periphery of each unit sticker 21. The half-cutting line 22 extends from the upper surface of the upper sheet 20 to the adhesive 40 to allow the sticker 21 to be separated from the lower sheet 10 coated with the silicon layer 40 and a portion 23 of the upper sheet where there is no unit sticker. The half-cutting lines 22 are indicated by colored lines 22a printed on the upper surface of the upper sheet 20 with a printing ink or paint while corresponding to the half-cutting lines, respectively.

In accordance with the present invention, the half-cutting lines and colored lines are formed by dipping a blade of a half-cutting tool in a paint or bringing the blade into contact with the paint, and cutting respective peripheries of unit stickers at the upper sheet using the paint-stained blade. In accordance with this method, the colored lines corresponding to the half-cutting lines are formed on an upper surface of the upper sheet, simultaneously with the formation of the half-cutting lines.

The sticker sheet with printed colored lines according to the present invention is available for general purposes including stickers for use in children's learning materials and novelties as well as for use with computers and common printings. Particularly, in case the sticker sheet is used as a computer print sheet, it can be conveniently used, because its regions to be printed are definitely indicated by the colored lines.

Industrial Applicability

As apparent from the above description, the present invention provides a sticker sheet which has half-cutting lines formed by cutting respective peripheries of unit stickers and adapted to define these unit stickers, and printed colored lines corresponding to the half-cutting lines, to clearly define the shape of the stickers, so that the user can easily separate each sticker and conveniently use it. Also, where the process for forming half-cutting lines is carried out using a blade of a half-cutting tool stained with a paint, the colored lines can be printed, simultaneously with the formation of the half-cut lines. Accordingly the sticker sheet can be manufactured at substantially the same costs as those of conventional sticker sheets. Furthermore, since the colored lines correspond exactly to the half-cutting lines, they are not seen when the stickers are reattached to other objects.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A sticker sheet comprising a lower sheet, and an upper sheet attached to an upper surface of the lower sheet and formed with half-cutting lines respectively adapted to separate unit stickers from the upper sheet, further comprising colored lines printed on an upper surface of the upper sheet, the colored lines corresponding to the half-cutting lines, respectively.

2. A method for forming half-cutting lines adapted to separate unit stickers from an upper sheet included in a sticker sheet including a lower sheet, in addition to the upper sheet, comprising the steps of:
staining a blade of a half-cutting tool with a paint; and
cutting respective peripheries of unit stickers at the upper sheet using the paint-stained blade,
thereby forming the half-cutting lines while simultaneously printing, on an upper surface of the upper sheet, colored lines corresponding to the half-cutting lines.
